(19) United States
(12) Patent Application Publication
(10) Pub. No.: US 2024/0160464 A1
(43) Pub. Date: May 16, 2024

(54) INSTRUCTION SENDING METHOD AND APPARATUS

(71) Applicant: Beijing Bytedance Network Technology Co., Ltd., Beijing (CN)

(72) Inventors: Haozhong ZHANG, Beijing (CN); Yang ZHANG, Beijing (CN); Qiao DENG, Beijing (CN)

(21) Appl. No.: 18/283,700

(22) PCT Filed: Mar. 11, 2022
(86) PCT No.: PCT/CN2022/080256

§ 371 Date: Sep. 22, 2023

(30) Foreign Application Priority Data
Apr. 8, 2021 (CN) 202110379558.5

(51) Int. Cl. G06F 9/455

(52) U.S. Cl. CPC G06F 9/45558; G06F 9/45545; G06F 2009/45583

(57) ABSTRACT

An embodiment of the present disclosure provides an instruction sending method and apparatus and relates to the technical field of computers. The method includes: switching an extended page table (EPT) from a first EPT to a second EPT, in response to an instruction sending request for sending a target instruction to a second processor; obtaining a target code according to the second EPT, the target code being a code related to sending the target instruction; executing the target code, to make the first processor sends the target instruction to the second processor. The embodiment of the present disclosure is used to avoid an inter-processor instruction from being utilized by an attacker, and meanwhile, avoid performance of a virtual machine from being greatly influenced when an instruction is sent.

### CROSS-REFERENCE TO RELATED APPLICATION

The present application claims priority to Chinese patent Application No. 202110379558.5, filed on Apr. 8, 2021, and titled “INSTRUCTION SENDING METHOD AND APPARATUS”, all contents of which are combined in the present disclosure through reference.

### TECHNICAL FIELD

The present disclosure relates to the field of computer technologies, and more particularly, to an instruction sending method and apparatus.

### BACKGROUND

In a multiprocessor system, a processor often sends instructions to other processors in the system, while some of the instructions may be utilized by an attacker to threaten system security, and such instructions which may be utilized by the attacker are referred to as sensitive instructions. For example, Inter-Processor Interrupt (IPI) instructions, which may be utilized by the attacker to send interrupts to other processors, causing other processors to have exception interrupts.

In order to improve security of the multiprocessor system, in the current virtualization technology, a behavior that a virtual machine sends sensitive instructions such as IPI will be intercepted by a Hypervisor, the Hypervisor executes an actual sending operation of the sensitive instruction, and control authority of the processor is returned to the virtual machine after the sensitive instruction is sent. A hardware-assisted virtualization technology pushed out by a hardware manufacturer provides support for this mode. Exemplarily, the virtual machine is set to run in a non-root mode, the hypervisor is set to run in a root mode. The virtual machine being switched from the non-root mode to the root mode is referred to a VM Exit, indicating that the virtual machine loses the control authority of the processor, and the Hypervisor takes over the control authority of the processor. The virtual machine being switched from the root mode to the non-root mode is called a VM Entry, indicating that the Hypervisor returns the control authority of the processor to the virtual machine, and when the virtual machine executes the sending of the sensitive instruction such as the IPI, the VM Exit will occur, and the Hypervisor executes the sending of the sensitive instruction, and obtains the control authority of the processor through the VM Entry after the sending is completed. Since the VM Exit occurs when the virtual machine sends the IPI and other sensitive instructions in the current virtualization technology, the control authority of the processor needs to be re-obtained through the VM Entry after the sensitive instruction is sent. However, the VM Exit and the VM Entry can generate great performance consumption, so that the sensitive instruction sending mode in the current virtualization technology can greatly influence the performance of the virtual machine.

### SUMMARY

In view of the above, an embodiment of the present disclosure provides an instruction sending method and apparatus, for avoiding relatively large influence on the performance of the virtual machine when sending an instruction while avoiding Inter-Processor Interrupt instructions from being used by an attacker.

In order to achieve the above embodiment, the embodiment of the present disclosure provides the following technical schemes.

According to a first aspect, an embodiment of the present disclosure provides an instruction sending method, which is applied to a first processor, and the method includes: switching an extended page table (EPT) from a first EPT to a second EPT, in response to an instruction sending request for sending a target instruction to a second processor; obtaining a target code according to the second EPT, the target code being a code related to sending the target instruction; and executing the target code, to make the first processor sends the target instruction to the second processor.

In at least one embodiment of the present disclosure, the switching the EPT from the first EPT to the second EPT includes: obtaining a springboard code according to the first EPT; and executing the springboard code, to make switch the EPT from the first EPT to the second EPT.

In at least one embodiment of the present disclosure, the obtaining the springboard code according to the first EPT includes: accessing a first physical page according to a guest physical address (GPA) of the first physical page and a first mapping relationship in the first EPT, to obtain a first page table, the first mapping relationship is a mapping relationship between the GPA of the first physical page and a host physical address HPA of the first physical page, and the first page table includes a conversion relationship between a guest virtual address GVA of a second physical page and a GPA of the second physical page; obtaining the GPA of the second physical page according to the GVA of the second physical page and the first page table; and accessing the second physical page according to the GPA of the second physical page and a second mapping relationship in the first EPT, to obtain the springboard code, and the second mapping relationship is a mapping relationship between the GPA of the second physical page and a HPA of the second physical page.

In at least one embodiment of the present disclosure, the obtaining the target code according to the second EPT includes: accessing a third physical page according to a GPA of the third physical page and a third mapping relationship of the second EPT, to obtain a second page table; the third mapping relationship is a mapping relationship between the GPA of the third physical page and a HPA of the third physical page, and the second page table includes a conversion relationship between a GVA of a fourth physical page and a GPA of the fourth physical page; obtaining the GPA of the fourth physical page according to the GVA of the fourth physical page and the second page table; and accessing the fourth physical page according to the GPA of the fourth physical page and a fourth mapping relationship of the second EPT, to obtain the target code; the fourth mapping relationship is a mapping relationship between the GPA of the fourth physical page and a HPA of the fourth physical page.

In at least one embodiment of the present disclosure, after executing the target code, the method further includes: obtaining a springboard code according to the second EPT; and executing the springboard code, to switch the EPT from the second EPT to the first EPT.

In at least one embodiment of the present disclosure, obtaining the springboard code according to the second EPT includes: accessing a first physical page according to a GPA of the first physical page and a first mapping relationship in the second EPT, to obtain a first page table; the first mapping relationship is a mapping relationship between the GPA of the first physical page and a HPA of the first physical page, and the first page table includes a conversion relationship between a GVA of the second physical page and a GPA of the second physical page; obtaining the GPA of the second physical page according to the GVA of the second physical page and the first page table; and accessing the second physical page according to the GPA of the second physical page and a second mapping relationship in the second EPT, to obtain the springboard code, and the second mapping relationship is a mapping relationship between the GPA of the second physical page and a HPA of the second physical page.

In at least one embodiment of the present disclosure, the method further includes: before the target code is executed, assigning values to an extended stack pointer (ESP) and an extended base pointer (EBP) according to a first GPA, and the first GPA is a GPA corresponding to a stack space of the first processor when the EPT is the second EPT; and, assigning values to the ESP and the EBP according to a second GPA after executing the target code, and the second GPA is a GPA corresponding to a stack space of the first processor when the EPT is the first EPT.

In at least one embodiment of the present disclosure, the method further includes: saving a first register context; the first register context is a context of a register of the first processor after assigning values to the ESP and the EBP according to the first GPA; and restoring the context of the register of the first processor to the first register context after executing the target code.

In at least one embodiment of the present disclosure, the method further includes: saving a second register context, the second register context being a context of a register of the first processor when the EPT is switched from the first EPT to the second EPT; and restoring the context of the register of the first processor to the second register context after switching the EPT from the second EPT to the first EPT.

In at least one embodiment of the present disclosure, the method further includes: turning off a local interrupt of the first processor before saving the second register context; and turning on the local interrupt of the first processor after restoring the context of the register of the first processor to the second register context.

In at least one embodiment of the present disclosure, the springboard code includes: an EPTP switch instruction; the executing the springboard code includes: calling the EPTP switch instruction in the springboard code.

In at least one embodiment of the present disclosure, after executing the springboard code, the method further includes: performing security check on the second processor; and terminating sending the target instruction to the second processor in response to the security check failing.

In at least one embodiment of the present disclosure, the method further includes, prior to obtaining the springboard code according to the first EPT: configuring the first physical page and the second physical page, and constructing the first mapping relationship and the second mapping relationship in the first EPT.

In at least one embodiment of the present disclosure, the method further includes, prior to obtaining the target code according to the second EPT: configuring the third physical page and the fourth physical page, and constructing the third mapping relationship and the fourth mapping relationship in the second EPT.

In at least one embodiment of the present disclosure, the method further includes, prior to switching the EPT from the first EPT to the second EPT: writing the GPA of the third physical page into the first EPT, and setting an attribute of the GPA of the third physical page to be read-only.

In at least one embodiment of the present disclosure, the method further includes, prior to obtaining the springboard code according to the second EPT: configuring the first physical page and the second physical page, and constructing the first mapping relationship and the second mapping relationship in the second EPT.

In at least one embodiment of the present disclosure, the target instruction is an inter-processor interrupt IPI instruction, and the target code is a code related to sending the IPI instruction.

According to a second aspect, an embodiment of the present disclosure provides an instruction sending apparatus, and the instruction sending apparatus includes a first processor, including: a switching unit, used for switching an extended page table EPT from a first EPT to a second EPT in response to an instruction sending request of sending a target instruction to a second processor from the first processor of the instruction sending apparatus; an obtaining unit, used for obtaining a target code according to the second EPT, the target code being a code related to sending the target instruction; and an execution unit, used for executing the target code, to make the first processor send the target instruction to the second processor.

In at least one embodiment of the present disclosure, the switching unit is exemplary used for obtaining a springboard code according to the first EPT; and executing the springboard code, to switch the EPT from the first EPT to the second EPT.

In at least one embodiment of the present disclosure, the switching unit is exemplary used for accessing a first physical page according to a guest physical address (GPA) of the first physical page and a first mapping relationship in the first EPT, to obtain a first page table; the first mapping relationship is a mapping relationship between the GPA of the first physical page and a host physical address HPA of the first physical page, and the first page table includes a conversion relationship between a guest virtual address GVA of a second physical page and a GPA of the second physical page; obtaining the GPA of the second physical page according to the GVA of the second physical page and the first page table; accessing the second physical page according to the GPA of the second physical page and a second mapping relationship in the first EPT, to obtain the springboard code, and the second mapping relationship is a mapping relationship between the GPA of the second physical page and the HPA of the second physical page.

In at least one embodiment of the present disclosure, the obtaining unit is exemplary used for accessing a third physical page according to a GPA of the third physical page and a third mapping relationship of the second EPT, to obtain a second page table; the third mapping relationship is a mapping relationship between the GPA of the third physical page and a HPA of the third physical page; the second page table includes a conversion relationship between a GVA of the fourth physical page and a GPA of the fourth physical page; obtaining the GPA of the fourth physical page according to the GVA of the fourth physical page and the second page table; accessing the fourth physical page according to the GPA of the fourth physical page and a fourth mapping relationship of the second EPT, to obtain the target code; the fourth mapping relationship is a mapping relationship between the GPA of the fourth physical page and the HPA of the fourth physical page.

In at least one embodiment of the present disclosure, the switching unit is further used for obtaining a springboard code according to the second EPT after the execution unit executes the target code; and executing the springboard code, to switch the EPT from the second EPT to the first EPT.

In at least one embodiment of the present disclosure, the switching unit is exemplary used for accessing the first physical page according to the GPA of the first physical page and the first mapping relationship in the second EPT, to obtain the first page table; the first mapping relationship is the mapping relationship between the GPA of the first physical page and the HPA of the first physical page, and the first page table includes the conversion relationship between the GVA of the second physical page and the GPA of the second physical page; obtaining the GPA of the second physical page according to the GVA of the second physical page and the first page table; and accessing the second physical page according to the GPA of the second physical page and the second mapping relationship in the second EPT, to obtain the springboard code, and the second mapping relationship is the mapping relationship between the GPA of the second physical page and the HPA of the second physical page.

In at least one embodiment of the present disclosure, the execution unit is further used for assigning values to an extended stack pointer ESP and an extended base pointer EBP according to the first GPA before executing the target code, and the first GPA is a GPA corresponding to a stack space of the first processor when the EPT is the second EPT; assigning values to the ESP and the EBP according to the second GPA after the target code is executed, and the second GPA is a GPA corresponding to a stack space of the first processor when the EPT is the first EPT.

In at least one embodiment of the present disclosure, the execution unit is further used for saving a first register context; the first register context is a context of a register of the first processor after assigning values to the ESP and the EBP according to the first GPA; restoring the context of the register of the first processor to the first register context after executing the target code.

In at least one embodiment of the present disclosure, the execution unit is further used for saving a second register context, and the second register context is a context of a register of the first processor when the EPT is switched from the first EPT to the second EPT; restoring the context of the register of the first processor to the second register context after the EPT is switched from the second EPT to the first EPT.

In at least one embodiment of the present disclosure, the execution unit is further used for turning off a local interrupt of the first processor before saving the second register context; turning on the local interrupt of the first processor after the context of the register of the first processor is restored to the second register context.

In at least one embodiment of the present disclosure, the springboard code includes: an EPTP switch instruction; the switching unit is exemplary used for calling the EPTP switch instruction in the springboard code.

In at least one embodiment of the present disclosure, the switching unit is further used for performing security check on the second processor after executing the springboard code; and terminating the sending of the target instruction to the second processor in response to the security check failing.

In at least one embodiment of the present disclosure, the switching unit is further used for configuring the first physical page and the second physical page before obtaining the springboard code according to the first EPT, and for constructing the first mapping relationship and the second mapping relationship in the first EPT.

In at least one embodiment of the present disclosure, the obtaining unit is further used for configuring the third physical page and the fourth physical page before obtaining the target code according to the second EPT, and for constructing the third mapping relationship and the fourth mapping relationship in the second EPT.

In at least one embodiment of the present disclosure, the obtaining unit is further used for writing the GPA of the third physical page in the first EPT before switching the EPT from the first EPT to the second EPT, and for setting an attribute of the GPA of the third physical page to be read-only.

In at least one embodiment of the present disclosure, the switching unit is further used for configuring the first physical page and the second physical page before obtaining the springboard code according to the second EPT, and for constructing the first mapping relationship and the second mapping relationship in the second EPT.

In at least one embodiment of the present disclosure, the target instruction is an Inter-Processor Interrupt IPI instruction, and the target code is a code related to sending the IPI instruction.

According to a third aspect, an embodiment of the present disclosure provides an electronic apparatus, including: a memory and a processor, and the memory has a computer program stored thereon; the processor is configured to, when calling the computer program, execute the instruction sending method of the first aspect or any embodiments of the first aspect.

According to a fourth aspect, an embodiment of the present disclosure provides a computer readable storage medium, having a computer program stored thereon, the computer program, when executed by a processor, implementing the instruction sending method according to the first aspect or any embodiments of the first aspect.

According to a fifth aspect, an embodiment of the present disclosure provides a computer program product, which includes a computer program/instruction, and it realizes the instruction sending method according to the first aspect or any embodiments of the first aspect when the computer program is executed by the processor.

In response to an instruction sending request of sending the target instruction to the second processor by the first processor, the instruction sending method provided by the embodiment of the present disclosure switches the EPT from the first EPT to the second EPT, then obtains the target code related to the sending of the target instruction according to the second EPT, and then executes the target code, in order to make the first processor to send the target instruction to the second processor. On one hand, since the target code related to sending the target instruction can only be obtained through the second EPT, and the first EPT cannot obtain, if it is required to send the target instruction to the second processor through the first processor, firstly the EPT needs to be switched from the first EPT to the second EPT to execute a related operation of sending the target instruction, so that the embodiment of the present disclosure realizes isolation between the first processor and the target code, and the target instruction can be prevented from being utilized by an attacker to a certain extent. On the other hand, since the embodiment of the present disclosure does not need a virtual machine monitor when sending an inter-processor instruction, the virtual machine can directly send the target instruction in the non-root mode, which avoids performance loss in VM exit and VM entry processes of the virtual machine, so the embodiment of the present disclosure can avoid relatively large influence on the performance of the virtual machine when sending the target instruction. In conclusion, the embodiment of the present disclosure can avoid relatively large influence on the performance of the virtual machine when sending the target instruction while avoiding the inter-processor instruction from being utilized by an attacker.

### BRIEF DESCRIPTION OF DRAWINGS

The accompanying drawings being incorporated in and constitute a part of the description illustrate embodiments consistent with the present disclosure and are used to explain the principles of the present disclosure together with the description.

In order to illustrate the technical solutions more clearly in the embodiments of the present disclosure or the prior art, the drawings that need to be used in the description of the embodiments or the prior art are briefly described below. Obviously, a person of ordinary skill in the art can obtain other drawings according to these drawings without involving any inventive effort.

FIG. 1 is a first flowchart of an instruction sending method according to an embodiment of the present disclosure;

FIG. 2 is a second flowchart of an instruction sending method according to an embodiment of the present disclosure;

FIG. 3 is a structural schematic diagram of a first EPT and a second EPT according to an embodiment of the present disclosure;

FIG. 4 is a third flowchart of an instruction sending method according to an embodiment of the present disclosure;

FIG. 5 is a structural schematic diagram of an instruction sending apparatus according to an embodiment of the present disclosure;

FIG. 6 is a structural schematic diagram of a hardware of an electronic apparatus according to an embodiment of the present disclosure.

### DESCRIPTION OF EMBODIMENTS

In order to understand the above-mentioned embodiments, features, and advantages more clearly in the present disclosure, the aspects of the present disclosure are further described below. It should be noted that, in the case of no conflict, the embodiments of the present disclosure and the features in the embodiments may be combined with each other.

Numerous specific details are set forth in following description to facilitate a sufficient understanding of the present disclosure, but the present disclosure may be practiced otherwise than as described herein; obviously, the embodiments in the specification are only a portion of the embodiments of the present disclosure rather than all embodiments.

In the embodiments of the present disclosure, words such as “exemplary” or “for example” are used to represent an example, illustration, or description. Any embodiment or design scheme described as “exemplary” or “for example” in the embodiments of the present disclosure should not be construed as being more preferred or more advantageous than other embodiments or design schemes. In particular, the words such as “exemplary” or “for example” are intended to present related concepts in a specific manner. In addition, in the description of the embodiment of the present disclosure, unless otherwise specified, the meaning of “a plurality of” means two or more.

Firstly, user-defined terms in the embodiments of the present disclosure are described below.

A first EPT: a EPT before a first processor performs EPT switching, including a first mapping relationship and a second mapping relationship, and not including a third mapping relationship and a fourth mapping relationship.

A second EPT: a EPT after the first processor performs the EPT switching, including the first mapping relationship, the second mapping relationship, the third mapping relationship and the fourth mapping relationship.

The first mapping relationship: a mapping relationship between a GPA of a first physical page and a HPA of the first physical page.

The second mapping relationship: a mapping relationship between a GPA of a second physical page and a HPA of the second physical page.

The third mapping relationship: a mapping relationship between a GPA of a third physical page and a HPA of the third physical page.

The fourth mapping relationship: a mapping relationship between a GPA of a fourth physical page and a HPA of the fourth physical page.

The first physical page: a physical page saving a first page table.

The second physical page: a physical page saving a springboard code.

The third physical page: a physical page saving a second page table.

The fourth physical page: a physical page saving a target code.

The first page table: a page table containing a conversion relationship between a GVA of the second physical page and the GPA of the second physical page.

The second page table: a page table containing a conversion relationship between a GVA of the fourth physical page and the GPA of the fourth physical page.

The target code: a code related to sending a target instruction.

The springboard code: used for switching an EPT corresponding to the first processor between the first EPT and the second EPT.

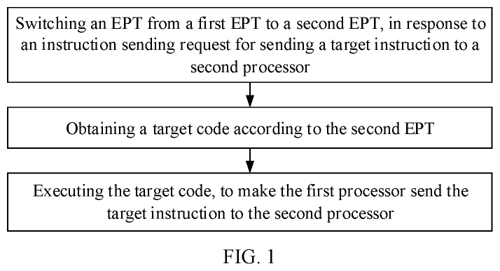

Based on content above, an embodiment of the present disclosure provides an instruction sending method applied to the first processor, and with reference to FIG. 1, the instruction sending method provided by the embodiment of the present disclosure includes following blocks.

S101, an extended page table (EPT) is switched from the first EPT to the second EPT, in response to an instruction sending request for sending a target instruction to a second processor.

Exemplarily, in a memory virtualization aspect of a virtual machine technology, when a virtual machine runs a guest code in a non-root mode, an address used is a guest virtual address (GVA), and it is required to perform address conversion through a guest page table to obtain a guest physical address (GPA), the GPA needs to be subjected to secondary address conversion and converted into a host physical address (HPA) for access, and in the Intel virtualization technology, a page table used in the process of converting the GPA into the HPA is called EPT.

It should be noted that the first processor and the second processor in the embodiments of the present disclosure may belong to the same virtual machine or may respectively belong to different virtual machines, which is not limited in the embodiments of the present disclosure.

Intel increases support for a VM Function mechanism. That is, in the non-root mode, an instruction sending operation can be directly executed by means of a VMFUNC instruction, without generating a VM exit, and a new value is allowed to be loaded for an EPTP in the non-root mode, so that another EPT paging structure is established. Based on the VM Function mechanism, two EPTs (the first EPT and the second EPT) are created for a virtual machine to which the first processor belongs, and the first EPT is an original EPT of the client and contains a kernel code of the client, its establishment follows an EPT violation process of KVM (a Linux-based open source virtualization technology), a general code in an operating system and an application of the client establishes address mapping in the first EPT, and the target code only establishes an address mapping in the second EPT, so that before a target instruction is sent to the second processor, the EPT corresponding to the first processor needs firstly to be switched from the first EPT to the second EPT.

Exemplarily, an embodiment of switching the EPT from the first EPT to the second EPT may include: obtaining a springboard code according to the first EPT; and executing the springboard code, to switch the EPT from the first EPT to the second EPT.

S102, a target code is obtained according to the second EPT.

The target code is a code related to sending the target instruction.

Exemplarily, since the target code related to sending of the target instruction establishes the address mapping in the second EPT, the target code can be obtained according to the second EPT.

S103, the target code is executed, to make the first processor to send the target instruction to the second processor.

In response to an instruction sending request of sending the target instruction to the second processor by the first processor, the instruction sending method provided by the embodiment of the present disclosure switches the EPT from the first EPT to the second EPT, then obtains the target code related to the sending of the target instruction according to the second EPT, and then executes the target code, in order to make the first processor to send the target instruction to the second processor. On one hand, since the target code related to sending the target instruction can only be obtained through the second EPT and the first EPT cannot obtain, if it is required to send the target instruction to the second processor through the first processor, firstly the EPT needs to be switched from the first EPT to the second EPT to execute the related operation of sending the target instruction, so that the embodiment of the present disclosure realizes isolation between the first processor and the target code, and the target instruction can be prevented from being utilized by an attacker to a certain extent. On the other hand, since the embodiment of the present disclosure does not need a virtual machine monitor when sending an inter-processor instruction, the virtual machine can directly send the target instruction in the non-root mode, which avoids performance loss in VM exit and VM entry processes of the virtual machine, so the embodiment of the present disclosure can avoid relatively large influence on the performance of the virtual machine when sending the target instruction. In conclusion, the embodiment of the present disclosure can avoid relatively large influence on the performance of the virtual machine when sending the target instruction while avoiding the inter-processor instruction from being utilized by an attacker.

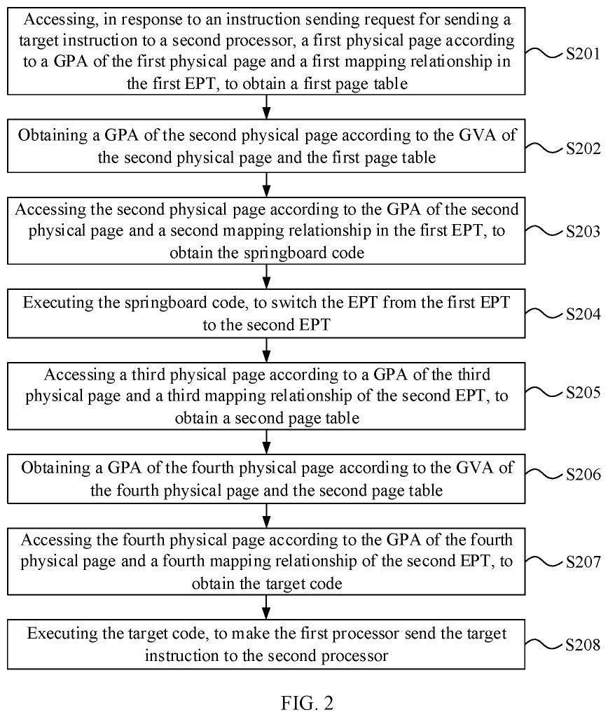

As expansion and refinement of the above embodiments, an embodiment of the present disclosure provides another instruction sending method, and as shown in FIG. 2, the instruction sending method includes following blocks.

S201, in response to an instruction sending request for sending the target instruction to the second processor, the first physical page is accessed according to the GPA of the first physical page and the first mapping relationship in the first EPT, to obtain the first page table.

The first mapping relationship is the mapping relationship between the GPA of the first physical page and the HPA of the first physical page, the first physical page is a physical page saving the first page table, and the first page table includes the conversion relationship between the guest virtual address GVA of the second physical page and the GPA of the second physical page.

Exemplarily, when a base address of the guest page table used for converting the GVA into the GPA is stored in a CR3 register, a value of the CR3 register can be modified into the GPA of the first physical page, to access the first physical page according to the GPA of the first physical page and the first mapping relationship in the first EPT, to obtain the first page table.

S202: the GPA of the second physical page is obtained according to the GVA of the second physical page and the first page table.

Exemplarily, since the first page table is a page table used for defining the conversion relationship between the GVA of the second physical page and the GPA of the second physical page, the first page table can be searched according to the GVA of the second physical page, to obtain the GPA of the second physical page.

S203, the second physical page is accessed according to the GPA of the second physical page and the second mapping relationship in the first EPT, to obtain the springboard code.

The second physical page is a physical page saving the springboard code, and the second mapping relationship is a mapping relationship between the GPA of the second physical page and the HPA of the second physical page.

Since the second mapping relationship is the mapping relationship between the GPA of the second physical page and the HPA of the second physical page, the second mapping relationship can be searched based on the GPA of the second physical page obtained in the block S202, to obtain the HAP of the second physical page, and then the second physical page is accessed according to the HAP of the second physical page. Since the second physical page is the physical page saving the springboard code, the springboard code can be further obtained.

S204, the springboard code is executed, to switch the EPT from the first EPT to the second EPT.

Since the springboard code is a code used for switching the EPT corresponding to the first processor between the first EPT and the second EPT, and the EPT corresponding to the current first processor is the first EPT, the EPT corresponding to the first processor can be switched from the first EPT to the second EPT by executing the springboard code.

Exemplarily, the springboard code includes: an EPTP switch instruction, and an embodiment of executing the springboard code in the block S204 can include: calling the EPTP switch instruction in the springboard code, to switch the EPT corresponding to the first processor from the first EPT to the second EPT.

Since the EPTP switch instruction needs to be called in the above embodiments in order to switch the EPT corresponding to the first processor from the first EPT to the second EPT, before the EPTP switch instruction is called, the instruction sending method provided by the embodiment of the present disclosure further includes: enabling EPTP Switch function.

Exemplarily, an embodiment of enabling the EPTP Switch function can include following steps:
Step 1, setting the enable VM functions in a secondary processor-based VM-execution control in a control field of a virtual machine control structure (VMCS) of the processor to 1.
Step 2, setting EPTP Switching in a VM-function Control field to 1.
Step 3, writing EPTP list entry into a pre-configured fifth physical page.
Step 4, writing GPA of the pre-configured physical page into the VMCS.

It should be noted that in the embodiment of the present disclosure, sequence of the steps 1 to 4 executed practically in the process of enabling the EPTP Switch function is not limited, and a person skilled in the art can execute the steps 1 to 4 in any sequence according to requirements.

Furthermore, when the instruction sending method provided by the embodiment of the present disclosure switches the EPT corresponding to the first processor from the first EPT to the second EPT by executing a jump code, before executing the jump code to switch the EPT corresponding to the first processor from the first EPT to the second EPT, the first physical page and the second physical page also need to be configured, and the first mapping relationship and the second mapping relationship are constructed in the first EPT, so the instruction sending method provided by the embodiment of the present disclosure further includes: configuring the first physical page and the second physical page; and constructing the first mapping relationship and the second mapping relationship in the first EPT.

Exemplarily, two blank physical pages of a preset size can be allocated, then a first page table is written into one of the blank physical pages to generate the first physical page, the springboard code is written into the other blank physical page to generate the second physical page, and finally the first mapping relationship is constructed in the first EPT according to the GPA of the first physical page and the HAP of the first physical page, and the second mapping relationship is constructed in the first EPT according to the GPA of the second physical page and the HAP of the second physical page.

It should be noted that in the embodiment of the present disclosure, the sequence of configuring the first physical page and configuring the second physical page is not limited, and the sequence of constructing the first mapping relationship and the second mapping relationship in the first EPT is not limited.

S205, a third physical page is accessed according to the GPA of the third physical page and a third mapping relationship of the second EPT to obtain a second page table.

The third mapping relationship is a mapping relationship between the GPA of the third physical page and HPA of the third physical page; and the third physical page is a physical page saving the second page table, and the second page table includes the conversion relationship between the GVA of the fourth physical page and the GPA of the fourth physical page.

In practical application, a base address of the guest page table used for converting the GVA into the GPA is stored in the CR3 register, so that the value of the CR3 register can be modified into the GPA of the third physical page, to access the third physical page according to the GPA of the third physical page and the third mapping relationship, to obtain the second page table.

Since the third mapping relationship is the mapping relationship between the GPA of the third physical page and the HPA of the third physical page, the HPA of the third physical page can be obtained based on the GPA of the third physical page, and then the third physical page is accessed according to the HPA of the third physical page. Since the third physical page is the physical page saving the second page table, content of the second page table can be further obtained.

S206, the GPA of the fourth physical page is obtained according to the GVA of the fourth physical page and the second page table.

Exemplarily, since the second page table is used for defining the conversion relationship between the GVA of the fourth physical page and the GPA of the fourth physical page, the GPA of the fourth physical page can be obtained based on the GVA of the fourth physical page and the second page table.

S207, the fourth physical page is accessed according to the GPA of the fourth physical page and the fourth mapping relationship of the second EPT, to obtain the target code.

The fourth physical page is a physical page saving the target code, and the fourth mapping relationship is a mapping relationship between the GPA of the fourth physical page and the HPA of the fourth physical page.

Since the fourth mapping relationship is the mapping relationship between the GPA of the fourth physical page and the HPA of the fourth physical page, and block S206 obtains the GPA of the fourth physical page, the HPA of the fourth physical page can be obtained according to the GPA of the fourth physical page and the fourth mapping relationship, and then the fourth physical page is accessed according to the HPA of the third physical page. In addition, since the fourth physical page is a physical page saving the target code related to the sending of the target instruction, the target code can be obtained.

Furthermore, since the instruction sending method provided by the embodiment needs to switch the EPT corresponding to the first processor from the first EPT to the second EPT in the process of sending the target instruction and uses the third mapping relationship and the fourth mapping relationship in the second EPT, before the blocks and flowchart of the instruction sending method provided by the embodiment, the instruction sending method provided by the embodiment of the present disclosure also needs to configure the third physical page and the fourth physical page and construct the third mapping relationship and the fourth mapping relationship in the second EPT, so as to obtain the target code according to the second EPT. The instruction sending method provided by the embodiment of the present disclosure further includes: configuring the third physical page and the fourth physical page; and constructing the third mapping relationship and the fourth mapping relationship in the second EPT.

Exemplarily, two blank physical pages of a preset size can be allocated, then the second page table is written into one of the blank physical pages to generate the third physical page, the target code is written into the other blank physical page to generate the fourth physical page, and finally the third mapping relationship is constructed in the second EPT according to the GPA of the third physical page and the HAP of the third physical page, and the fourth mapping relationship is constructed in the second EPT according to the GPA of the fourth physical page and the HAP of the fourth physical page.

It should be noted that in the embodiment of the present disclosure, the sequence of configuring the third physical page and configuring the fourth physical page is not limited, and the sequence of constructing the third mapping relationship and the fourth mapping relationship in the second EPT is not limited.

S208, the target code is executed, to make the first processor to send the target instruction to the second processor.

The implementation principles and the technical effects of the instruction sending method provided by the embodiment of the present disclosure are similar with those of the instruction sending method shown in FIG. 1, and details are not repeated here.

As an exemplary embodiment of the present disclosure, after the block S208, the instruction method provided by the embodiment of the present disclosure further includes: obtaining a springboard code according to the second EPT; and executing the springboard code to switch the EPT from the second EPT to the first EPT.

Similarly, in the above blocks, an embodiment of executing the springboard code to switch the EPT corresponding to the first processor from the second EPT to the first EPT can include: calling the EPTP switch instruction in the springboard code, to switch the EPT corresponding to the first processor from the first EPT to the second EPT.

It should be noted that if the EPT corresponding to the first processor is switched from the first EPT to the second EPT by calling the EPTP switch instruction in the springboard code, then before calling the EPTP switch instruction in the springboard code so as to switch the EPT corresponding to the first processor from the second EPT to the first EPT, the EPTP switch instruction is already enabled, and there is no need to make the EPTP switch instruction again, while if the EPT corresponding to the first processor is switched from the first EPT to the second EPT without calling the EPTP switch instruction in the springboard code, then before calling the EPTP switch instruction in the springboard code so as to switch the EPT corresponding to the first processor from the second EPT to the first EPT, it is necessary to enable the EPTP Switch function firstly. An embodiment of enabling the EPTP Switch function can be the same as the embodiment of enabling the EPTP Switch function in the embodiment described above, and details are not repeated here.

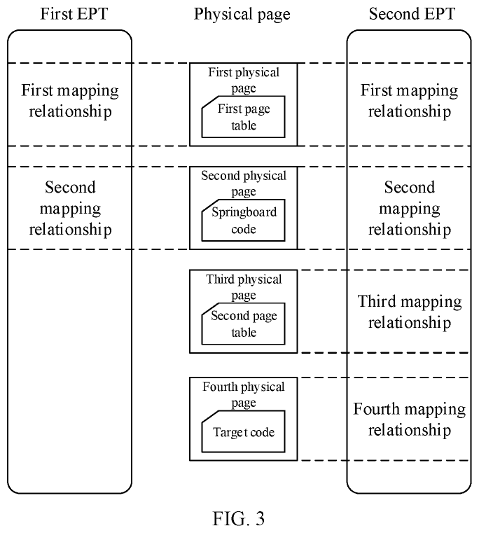

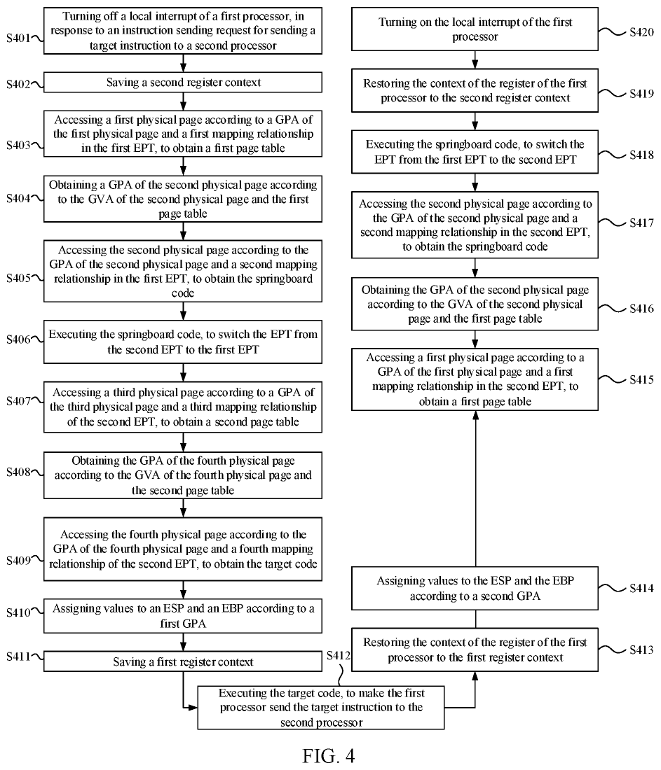

Referring to the structural schematic diagram of the first EPT and the second EPT shown in FIG. 3, the instruction sending method provided by the above embodiments is described by taking an example in which the first EPT includes the first mapping relationship and the second mapping relationship, and the second EPT includes the first mapping relationship, the second mapping relationship, the third mapping relationship and the fourth mapping relationship. Referring to FIG. 4, the instruction sending method provided by the embodiment of the present disclosure includes the following blocks.

S401, in response to the instruction sending request for sending the target instruction to the second processor, a local interrupt of the first processor is turned off.

By turning off the local interrupt of the first processor, the first processor will not receive an interrupt instruction sent by other processors anymore, or receives the interrupt instruction sent by other processors but not executing an interrupt operation, thereby preventing the first virtual machine from being interrupted in the process of sending the target instruction.

S402, a second register context is saved.

The second register context is a context of a register of the first processor when the EPT is switched from the first EPT to the second EPT.

That is, saving the context of the register generated by the first processor running the guest code before sending the target instruction.

By saving the second register context, the context of the register of the first processor can be quickly recovered after completing the target instruction sending.

S403, the first physical page is accessed according to the GPA of the first physical page and the first mapping relationship in the first EPT, to obtain the first page table.

S404, the GPA of the second physical page is obtained according to the GVA of the second physical page and the first page table.

S405, the second physical page is accessed according to the GPA of the second physical page and the second mapping relationship in the first EPT, to obtain the springboard code.

S406, the springboard code is executed, to switch the EPT from the first EPT to the second EPT.

S407, the third physical page is accessed according to the GPA of the third physical page and the third mapping relationship of the second EPT, to obtain the second page table.

S408, the GPA of the fourth physical page is obtained according to the GVA of the fourth physical page and the second page table.

S409, the fourth physical page is accessed according to the GPA of the fourth physical page and the fourth mapping relationship of the second EPT, to obtain the target code.

When the processor executes a new function, it needs to be switched to a new stack space, so before the target code is executed, a stack space of the first processor needs to be switched, and thus the target instruction execution method provided by the embodiment of the present disclosure further includes blocks S410 and S411 as follows.

S410, values are assigned to an extended stack pointer (ESP) and an extended base pointer (BSP) according to the first GPA.

The first GPA is GPA corresponding to the stack space of the first processor when the EPT corresponding to the first processor is the second EPT.

S411, a first register context is saved.

The first register context is a context of a register of the first processor after assigning values to the ESP and the EBP according to the first GPA.

That is, switching the stack space to a stack space corresponding to the second EPT.

S412, the target code is executed, to make the first processor send the target instruction to the second processor.

S413: the context of the register of the first processor is restored to the first register context.

Through the block S411 (saving the first register context) and the block S413 (restoring the context of the register of the first processor into the first register context), the stack space of the first processing can be quickly restored after the target code is executed.

S414, values are assigned to the ESP and the EBP according to the second GPA.

The second GPA is GPA corresponding to the stack space of the first processor when the EPT is the first EPT.

That is, the stack space of the first processing is restored to the stack space corresponding to the first EPT.

S415, the first physical page is accessed according to the GPA of the first physical page and the first mapping relationship in the second EPT, to obtain the first page table.

The first mapping relationship is a mapping relationship between the GPA of the first physical page and the HPA of the first physical page, the first page table includes the conversion relationship between the GVA of the second physical page and the GPA of the second physical page, and the first physical page is a physical page saving the first page table.

Exemplarily, the first mapping relationship is also saved in the second EPT, and the first mapping relationship is the mapping relationship between the GPA of the first physical page and the HPA of the first physical page, the HAP of the first physical page can be obtained according to the GPA of the first physical page and the first mapping relationship in the second EPT, and then the first physical page is accessed according to the HAP of the first physical page. Besides, since the first physical page is the physical page saving the first page table, the first physical page can be accessed to obtain the first page table.

In conclusion, when the base address of the guest page table used for converting the GVA into the GPA is stored in the CR3 register, the value of the CR3 register can be modified into the GPA of the first physical page, so that the first physical page is accessed according to the GPA of the first physical page and the first mapping relationship in the second EPT, and the first page table is obtained.

S416, the GPA of the second physical page is obtained according to the GVA of the second physical page and the first page table.

Exemplarily, since the first page table is a page table used for defining the conversion relationship between the GVA of the second physical page and the GPA of the second physical page, the first page table can be searched according to the GVA of the second physical page, to obtain the GPA of the second physical page.

S417, the second physical page is accessed according to the GPA of the second physical page and the second mapping relationship in the second EPT, to obtain the springboard code.

Exemplarily, since the second mapping relationship is the mapping relationship between the GPA of the second physical page and the HPA of the second physical page, the second mapping relationship can be searched based on the GPA of the second physical page obtained in the block S417, to obtain the HAP of the second physical page, and then the second physical page is accessed according to the HAP of the second physical page. And since the second physical page is the physical page saving the springboard code, the springboard code can be further obtained.

S418, the springboard code is executed, to switch the EPT corresponding to the first processor from the second EPT to the first EPT.

Similarly, when the instruction sending method provided by the embodiment of the present disclosure switches the EPT corresponding to the first processor from the second EPT to the first EPT by executing the jump code, before executing the jump code to switch the EPT corresponding to the first processor from the second EPT to the first EPT, it is also necessary to configure the first physical page and the second physical page, and the first mapping relationship and the second mapping relationship are constructed in the second EPT, so the instruction sending method provided by the embodiment of the present disclosure further includes: configuring the first physical page and the second physical page; and constructing the first mapping relationship and the second mapping relationship in the first EPT.

It should be noted that, if the EPT corresponding to the first processor is switched from the second EPT to the first EPT by executing the jump code, then before the EPT corresponding to the first processor is switched from the second EPT to the first EPT by executing the jump code, the first physical page and the second physical page have already been configured, so before the EPT corresponding to the first processor is switched from the first EPT to the second EPT by executing the jump code, there is only need to construct the first mapping relationship and the second mapping relationship in the second EPT, and it is enough to share the first physical page and the second physical page with the first EPT, without repeatedly carrying out the configuration of the first physical page and the second physical page.

S419, the context of the register of the first processor is restored to the second register context.

Through the block S402 (saving the second register context) and the block S419 (restoring the context of the register of the first processor to the second register context), the embodiment of the present disclosure can quickly recover the context of the register in the process of executing the guest code by the first processor after completing the target instruction sending.

S420, a local interrupt of the first processor is turned on.

By turning off the local interrupt of the first processor, it is possible to control the target content not to receive an interrupt instruction sent by other processors, or not to execute the interrupt operation after receiving the interrupt instruction sent by other processors, so that the first processor is prevented from being interrupted in the EPT switching process, and after the sending of the target instruction is completed, turning on the local interrupt of the first processor can ensure normal running of the guest.

Based on the above embodiments, the instruction sending method provided by the embodiment of the present disclosure further includes following steps after executing the springboard code: performing security check on the second processor; and the first processor is terminated to send the target instruction to the second processor in response to the security check failing.

Exemplarily, the guest operating system and the application program are run on the first EPT, and the target code related to sending the target instruction can only be accessed through the second EPT, so when the guest sends the target instruction, it is necessary to firstly switch to the second EPT through the springboard code provided in the first EPT, and then a key operation related to the sending of the target instruction is executed, whereas the springboard code must springboard to a specified code, so that the security check on the processor receiving the target instruction is performed after the springboard code is executed, which can further prevent an attacker from using the target instruction to interfere with other processors in the system, so as to further improve safety of the system.

Furthermore, based on the above embodiments, the instruction sending method provided by the embodiment of the present disclosure further includes: writing the GPA of the third physical page into the first EPT, and setting an attribute of the GPA of the third physical page to be read-only.

Although the above embodiment realizes isolation of the first processor from the target code, the attacker may still counterfeit the springboard code to achieve sending of the target instruction. A exemplary embodiment is: when the EPT corresponding to the first processor is the first EPT, the value of the CR3 register is modified into the GPA of the third physical page, and a page table of the springboard code is constructed by taking the GPA of the third physical page as the base address, then a virtual address of the counterfeited EPTP Switch instruction is placed in front of the virtual address of the fourth physical page, and in this way, after switching to the second EPT, due to the fact that values of all registers before and after the EPTP Switch are unchanged, the value of the CR3 in the second EPT points to the third physical page, and the instruction pointer register points to a next virtual address of the EPTP switch instruction, that is, it is mapped to the fourth physical page which the attacker tries to access, and then the target code in the fourth physical page is executed to send the target instruction.

As described above, the above attack manner requires that a page table that can be used to perform EPTP switch is forged in the first EPT, the GPA of the physical page storing the page table must be equal to the GPA of the third physical page in the second EPT, and the GPA of the physical page storing the page table in the first EPT can be modified. In the above embodiments, the GPA of the third physical page is written into the first EPT, and the attribute of the GPA of the third physical page is set to be read-only, so that an attacker cannot counterfeit the page table which can be used for the EPTP Switch in the first EPT, thereby avoiding the threat to the system security caused by the attack manner.

Through the same inventive concept, as an implementation of the method, the embodiment of the present disclosure further provides a target instruction sending apparatus, and an embodiment of the apparatus corresponds to the embodiment of the method, and in order to facilitate reading, the embodiment of the apparatus does not describe the detail content in the embodiment of the method one by one, but it should be clear, the target instruction sending apparatus in the present embodiment can correspondingly realize all the content in the embodiment of the method.

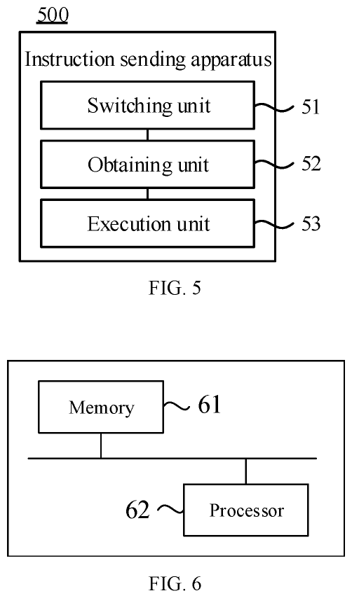

FIG. 5 is a structural schematic diagram of a target instruction sending apparatus provided by an embodiment of the present disclosure, and as shown in FIG. 5, the target instruction sending apparatus 500 provided by the present embodiment includes: a switching unit 51, an obtaining unit 52 and an execution unit 53.

The switching unit 51 is configured to switch an extended page table EPT from a first EPT to a second EPT in response to an instruction sending request of sending a target instruction to a second processor from a first processor of the instruction sending apparatus.

The obtaining unit 52 is configured to obtain a target code according to the second EPT, the target code being a code related to sending the target instruction.

The execution unit 53 is configured to execute the target code, to make the first processor send the target instruction to the second processor.

In at least one embodiment of the present disclosure, the switching unit 51 is exemplary used for obtaining a springboard code according to the first EPT; and executing the springboard code, to switch the EPT from the first EPT to the second EPT.

In at least one embodiment of the present disclosure, the switching unit 51 is exemplary used for accessing a first physical page according to a guest physical address (GPA) of the first physical page and a first mapping relationship in the first EPT, to obtain a first page table; the first mapping relationship is a mapping relationship between the GPA of the first physical page and a host physical address HPA of the first physical page, and the first page table includes a conversion relationship between a guest virtual address GVA of a second physical page and a GPA of the second physical page; obtaining the GPA of the second physical page according to the GVA of the second physical page and the first page table; accessing the second physical page according to the GPA of the second physical page and a second mapping relationship in the first EPT, to obtain the springboard code, and the second mapping relationship is a mapping relationship between the GPA of the second physical page and the HPA of the second physical page.

In at least one embodiment of the present disclosure, the obtaining unit 52 is exemplary used for accessing a third physical page according to a GPA of the third physical page and a third mapping relationship of the second EPT, to obtain a second page table; the third mapping relationship is a mapping relationship between the GPA of the third physical page and a HPA of the third physical page; the second page table includes a conversion relationship between a GVA of the fourth physical page and a GPA of the fourth physical page; obtaining the GPA of the fourth physical page according to the GVA of the fourth physical page and the second page table; accessing the fourth physical page according to the GPA of the fourth physical page and a fourth mapping relationship of the second EPT, to obtain the target code; the fourth mapping relationship is a mapping relationship between the GPA of the fourth physical page and the HPA of the fourth physical page.

In at least one embodiment of the present disclosure, the switching unit 51 is further used for obtaining a springboard code according to the second EPT after the execution unit executes the target code; and executing the springboard code, to switch the EPT from the second EPT to the first EPT.

In at least one embodiment of the present disclosure, the switching unit 51 is exemplary used for accessing the first physical page according to the GPA of the first physical page and the first mapping relationship in the second EPT, to obtain the first page table; the first mapping relationship is the mapping relationship between the GPA of the first physical page and the HPA of the first physical page, and the first page table includes the conversion relationship between the GVA of the second physical page and the GPA of the second physical page; obtaining the GPA of the second physical page according to the GVA of the second physical page and the first page table; and accessing the second physical page according to the GPA of the second physical page and the second mapping relationship in the second EPT, to obtain the springboard code, and the second mapping relationship is the mapping relationship between the GPA of the second physical page and the HPA of the second physical page.

In at least one embodiment of the present disclosure, the execution unit 53 is further used for assigning values to an extended stack pointer ESP and an extended base pointer EBP according to the first GPA before executing the target code, and the first GPA is a GPA corresponding to a stack space of the first processor when the EPT is the second EPT; assigning values to the ESP and the EBP according to the second GPA after the target code is executed, and the second GPA is a GPA corresponding to a stack space of the first processor when the EPT is the first EPT.

In at least one embodiment of the present disclosure, the execution unit 53 is further used for saving a first register context; the first register context is a context of a register of the first processor after assigning values to the ESP and the EBP according to the first GPA; restoring the context of the register of the first processor to the first register context after executing the target code.

In at least one embodiment of the present disclosure, the execution unit 53 is further used for saving a second register context, and the second register context is a context of a register of the first processor when the EPT is switched from the first EPT to the second EPT; restoring the context of the register of the first processor to the second register context after the EPT is switched from the second EPT to the first EPT.

In at least one embodiment of the present disclosure, the execution unit 53 is further used for turning off a local interrupt of the first processor before saving the second register context; turning on the local interrupt of the first processor after the context of the register of the first processor is restored to the second register context.

In at least one embodiment of the present disclosure, the springboard code includes: an EPTP switch instruction; the switching unit is exemplary used for calling the EPTP switch instruction in the springboard code.

In at least one embodiment of the present disclosure, the switching unit 51 is further used for performing security check on the second processor after executing the springboard code; and terminating the sending of the target instruction to the second processor in response to the security check failing.

In at least one embodiment of the present disclosure, the switching unit 51 is further used for configuring the first physical page and the second physical page before obtaining the springboard code according to the first EPT, and for constructing the first mapping relationship and the second mapping relationship in the first EPT.

In at least one embodiment of the present disclosure, the obtaining unit 52 is further used for configuring the third physical page and the fourth physical page before obtaining the target code according to the second EPT, and for constructing the third mapping relationship and the fourth mapping relationship in the second EPT.

In at least one embodiment of the present disclosure, the obtaining unit 52 is further used for writing the GPA of the third physical page in the first EPT before switching the EPT from the first EPT to the second EPT, and for setting an attribute of the GPA of the third physical page to be read-only.

In at least one embodiment of the present disclosure, the switching unit 51 is further used for configuring the first physical page and the second physical page before obtaining the springboard code according to the second EPT, and for constructing the first mapping relationship and the second mapping relationship in the second EPT.

In at least one embodiment of the present disclosure, the target instruction is an Inter-Processor Interrupt IPI instruction, and the target code is a code related to sending the IPI instruction.

The instruction sending apparatus provided by the embodiment of the present disclosure can execute the instruction sending method provided by the embodiment of the method described above, and an implementation principle and a technical effect are similar, which will not be repeated here.

Through the same inventive concept, the embodiment of the present disclosure further provides an electronic apparatus. FIG. 6 is a structural schematic diagram of the electronic apparatus provided by the embodiment of the present disclosure. As shown in FIG. 6, the electronic apparatus provided by the embodiment of the present disclosure includes a memory 61 and a processor 62, and the memory 61 has a computer program; the processor 62 is configured to, when calling the computer program, execute the steps of the instruction sending method provided by the embodiment.

The embodiment of the present disclosure further provides a computer readable storage medium, a computer program is stored on the computer readable storage medium, and when the computer program is executed by the processor, the steps of the instruction sending method provided by the embodiment are achieved.

Those skilled in the art should understand that the embodiments of the present disclosure can be provided as a method, a system, or a computer program product. Thus, the present disclosure may take forms of an entirely hardware embodiment, an entirely software embodiment, or an embodiment incorporating software and hardware aspects. Moreover, the present disclosure may take a form of a computer program product implemented on one or more computer-usable storage media including a computer-usable program code therein.

The processor may be a Central Processing Unit (CPU), or other general-purpose processor, Digital Signal Processor (DSP), Application-Specific Integrated Circuit (ASIC), Field-Programmable Gate Array (FPGA), or other programmable logic device, discrete gate or transistor logic device, discrete hardware component, etc. The general-purpose processor may be a micro-processor, or the processor may be any conventional processor or the like.

The memory may include a non-persistent memory, a random-access memory (RAM), and/or a non-volatile memory in a computer-readable medium, such as a read-only memory (ROM) or a flash memory (flash RAM). The memory is an example of a computer-readable medium.

The computer-readable medium includes permanent and non-permanent, removable, and non-removable storage media. The storage medium may implement information storage by any method or technology, and the information may be a computer-readable instruction, a data structure, a module of a program, or other data. Examples of the storage media of the computer include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, read-only disk read-only memory (CD-ROM), digital multifunctional optical disk (DVD) or other optical storage, magnetic cassette tape, magnetic disk storage or other magnetic storage devices, or any other non-transmission medium, which may be used to store information that can be accessed by a computing device. According to the definition herein, the computer-readable medium does not include transitory media, such as modulated data signals and carriers.

Finally, it is to be noted that the above embodiments are only provided to illustrate, rather than limiting, the technical solutions of the present disclosure. Although the present disclosure has been described in detail with reference to the above embodiments, it can be appreciated by those skilled in the art that the technical solutions recorded in the above embodiments can be modified, or some of the technical features thereof can be replaced with alternatives, without departing from the spirit and scope of the technical solutions according to various embodiments of the present disclosure.

1. An instruction sending method, applied to a first processor, the method comprising:
switching an extended page table (EPT) from a first EPT to a second EPT, in response to an instruction sending request for sending a target instruction to a second processor;
obtaining a target code according to the second EPT, the target code being a code related to sending the target instruction; and
executing the target code, to make the first processor send the target instruction to the second processor.

2. The method according to claim 1, wherein said switching the EPT from the first EPT to the second EPT comprises:
obtaining a springboard code according to the first EPT; and
executing the springboard code, to switch the EPT from the first EPT to the second EPT.

3. The method according to claim 2, wherein said obtaining the springboard code according to the first EPT comprises:
accessing a first physical page according to a guest physical address (GPA) of the first physical page and a first mapping relationship in the first EPT, to obtain a first page table, the first mapping relationship being a mapping relationship between the GPA of the first physical page and a host physical address (HPA) of the first physical page, and the first page table comprising a conversion relationship between a guest virtual address (GVA) of a second physical page and a GPA of the second physical page;
obtaining the GPA of the second physical page according to the GVA of the second physical page and the first page table; and
accessing the second physical page according to the GPA of the second physical page and a second mapping relationship in the first EPT, to obtain the springboard code, the second mapping relationship being a mapping relationship between the GPA of the second physical page and a HPA of the second physical page.

4. The method according to claim 1, wherein said obtaining the target code according to the second EPT comprises:
accessing a third physical page according to a GPA of the third physical page and a third mapping relationship of the second EPT, to obtain a second page table, the third mapping relationship being a mapping relationship between the GPA of the third physical page and a HPA of the third physical page, and the second page table comprising a conversion relationship between a GVA of a fourth physical page and a GPA of the fourth physical page;
obtaining the GPA of the fourth physical page according to the GVA of the fourth physical page and the second page table; and
accessing the fourth physical page according to the GPA of the fourth physical page and a fourth mapping relationship of the second EPT, to obtain the target code; the fourth mapping relationship is a mapping relationship between the GPA of the fourth physical page and a HPA of the fourth physical page.

5. The method according to claim 1, further comprising, subsequent to said executing the target code:
obtaining a springboard code according to the second EPT; and
executing the springboard code, to switch the EPT from the second EPT to the first EPT.

6. The method according to claim 5, wherein said obtaining the springboard code according to the second EPT comprises:
accessing a first physical page according to a GPA of the first physical page and a first mapping relationship in the second EPT, to obtain a first page table; the first mapping relationship being a mapping relationship between the GPA of the first physical page and a HPA of the first physical page, and the first page table comprising a conversion relationship between a GVA of a second physical page and a GPA of the second physical page;
obtaining the GPA of the second physical page according to the GVA of the second physical page and the first page table; and
accessing the second physical page according to the GPA of the second physical page and a second mapping relationship in the second EPT, to obtain the springboard code, the second mapping relationship being a mapping relationship between the GPA of the second physical page and a HPA of the second physical page.

7. The method according to claim 1, further comprising:
assigning values to an extended stack pointer (ESP) and an extended base pointer (EBP) according to a first GPA prior to said executing the target code, the first GPA being a GPA corresponding to a stack space of the first processor when the EPT is the second EPT; and
assigning values to the ESP and the EBP according to a second GPA after executing the target code, the second GPA being a GPA corresponding to a stack space of the first processor when the EPT is the first EPT.

8. The method according to claim 7, further comprising:
saving a first register context, the first register context being a context of a register of the first processor after assigning values to the ESP and the EBP according to the first GPA; and
restoring the context of the register of the first processor to the first register context after executing the target code.

9. The method according to claim 5, further comprising:
saving a second register context, the second register context being a context of a register of the first processor after switching the EPT from the first EPT to the second EPT; and
restoring the context of the register of the first processor to the second register context after switching the EPT from the second EPT to the first EPT.

10. The method according to claim 9, further comprising:
turning off a local interrupt of the first processor before saving the second register context; and
turning on the local interrupt of the first processor after restoring the context of the register of the first processor to the second register context.

11. The method according to claim 2, wherein
the springboard code comprises: an EPTP switch instruction; and
said executing the springboard code comprises:
calling the EPTP switch instruction in the springboard code.

12. The method according to claim 2, further comprising, subsequent to said executing the springboard code:
performing security check on the second processor; and
terminating, in response to the security check failing, sending the target instruction to the second processor.

13. The method according to claim 3, further comprising, prior to said obtaining the springboard code according to the first EPT:
configuring the first physical page and the second physical page; and
constructing the first mapping relationship and the second mapping relationship in the first EPT.

14. The method according to claim 4, further comprising, prior to said obtaining the target code according to the second EPT:
configuring the third physical page and the fourth physical page; and
constructing the third mapping relationship and the fourth mapping relationship in the second EPT.

15. The method according to claim 4, further comprising, prior to said switching the EPT from the first EPT to the second EPT:
writing the GPA of the third physical page into the first EPT; and
setting an attribute of the GPA of the third physical page as read-only.

16. The method according to claim 6, further comprising, prior to said obtaining the springboard code according to the second EPT:
configuring the first physical page and the second physical page; and
constructing the first mapping relationship and the second mapping relationship in the second EPT.

17. The method according to claim 1, wherein
the target instruction is an inter-processor interrupt IPI instruction; and
the target code is a code related to sending the IPI instruction.

18. (canceled)

19. An electronic apparatus, comprising:
a memory; and
a processor,
wherein the memory has a computer program stored thereon, wherein the processor is configured to, when calling the computer program, execute the instruction sending method according to claim 1.

20. A computer readable storage medium, having a computer program stored thereon, the computer program, when executed by a processor, implementing the instruction sending method according to claim 1.

21. The method according to claim 5, wherein
the springboard code comprises: an EPTP switch instruction; and
said executing the springboard code comprises:
calling the EPTP switch instruction in the springboard code.
